(19) United States
(12) Patent Application Publication
(10) Pub. No.: US 2009/0228332 A1
(43) Pub. Date: Sep. 10, 2009

(54) METHOD FOR THE ANALYSIS AND EVALUATION OF AN INDUSTRIAL ACTIVITY AND APPARATUS FOR IMPLEMENTING THIS METHOD

(75) Inventors: Luis MARTIN-DIAZ, Donauworth (DE); Stefan GLUCK, Ellgau (DE); Constantin TORNOW, Augsburg (DE); Silke KUSTERMANN, Buchs SG (CH)

Correspondence Address: YOUNG & THOMPSON, 209 Madison Street, Suite 500, ALEXANDRIA, VA, 22314, US

(73) Assignee: EUROCOPTER DEUTSCHLAND GMBH, Donauworth (DE)

(21) Appl. No.: 12/369,208

(22) Filed: Feb. 11, 2009

(30) Foreign Application Priority Data
Feb. 13, 2008 (EP) 08 002653.7

(51) Int. Cl. G06Q 10/00; G06Q 50/00; G06N 5/02

(52) U.S. Cl. 705/10; 705/7; 706/52

(57) ABSTRACT

A method for the technical and economic analysis of an industrial activity, includes:
collecting the data which relates to the industrial activity, and dividing the data into a first subgroup and a second subgroup,
processing data in all the subgroups in order to obtain a first value (v1) of an industrial parameter, known as internal capabilities, which corresponds to the first data subgroup and a second value of another industrial parameter, known as strategic importance which corresponds to the second data subgroup, wherein the values lie between zero and respectively predetermined limiting values and,
using a two-dimensional representation,
using transition values and, which are smaller than the limiting values and, and using the limiting values to delimit four approximately rectangular regions in the two-dimensional representation, each of which corresponds to a particular industrial evaluation,
localizing the region in which the industrial activity is located, which is defined by the values which represent the coordinates of a point in the two-dimensional representation,
issuing an evaluation report assigned to the industrial activity in such a manner, which provides information for creating an action plan.

The present invention relates to the general technical field of management of industrial activities. This management, which primarily takes into account industrial, financial, and strategic aspects, is frequently the reason for success or lack of success of the company. Such management may furthermore prove to be very complex, especially when this involves large companies or multinational groups. The data of technical, commercial, financial, social and other types, which accompany the industrial activity, are by their nature very different with regard to their meaning importance and presentation.

For this reason, it is particularly difficult to combine, connect or sum these data to obtain a simple and reliable overview of the industrial activity.

The object of the present invention is to provide a new method for the technical and economic analysis of an industrial activity, which makes it possible to overcome the aforesaid restrictions, which implements steps consisting in technically processing data and/or parameters relating to the industrial activity.

Another object of the present invention aims to propose a new apparatus for implementing the aforesaid method.

Another object of the present invention aims to provide a new computer program for implementing the aforesaid method.

Another object of the present invention aims to provide a new, particularly simple type of processing of data and parameters relating to an industrial activity, the results whereof may be used directly for creating an industrial strategy.

In the following description, the word “competence” is used, which must be understood as knowledge for executing an industrial task or activity well. The industrial activity is characterized by one or several special items of knowledge. The word “competence” can also directly designate the industrial activity. “Industrial activity” may therefore also be replaced by “competence”.

The professional core competence or profession core activity must be understood as a base activity or competence, which is present in the group, which is well mastered, and which has a high strategic importance in order to be placed in the market.

The objects assigned to the invention are achieved with the aid of a method for the technical and economic analysis of an industrial activity, which consists in:
collecting the data which relates to the industrial activity,
dividing the data into a first subgroup and a second subgroup,
processing the data in all the subgroups in order to obtain a first value (v1) of an industrial parameter, known as internal capabilities (IF), which corresponds to the first data subgroup and a second value (v2) of another industrial parameter, known as strategic importance (SB) which corresponds to the second data subgroup, wherein the said values (v1, v2) lie between a minimum value and respectively predetermined limiting values (IF_{L}) and (SB_{L}),
using a two-dimensional representation with a horizontal axis, which comprises the possible values of the industrial parameters, which corresponds to the internal capabilities (IF) and with a vertical axis which comprises the possible values of the industrial parameter, which corresponds to the strategic importance (SB),
using transition values (IF_{I}) and (SB_{J}), which are smaller than the limiting values (IF_{L}) and (SB_{L}), and using the said limiting values (IF_{L}) and (SB_{L}) of the said industrial parameters, to delimit four approximately rectangular regions (I, II, III, IV) in the two-dimensional representation, each of which corresponds to a particular industrial evaluation, localizing the region in which the industrial activity is located, which is defined by the values (v1, v2) which represent the coordinates of a point in the two-dimensional representation,
issuing an evaluation report assigned to the industrial activity in such a manner, which provides information for creating an action plan.

As a result of an example of implementation, the method according to the invention consists in collecting data relating to the industrial activity by means of a questionnaire.

As a result of an example of implementation, the method according to the invention consists in graphically visualizing at least the region (I, II, III or IV) in which the coordinate point (v1, v2) is localized.

As a result of an example of implementation, the method according to the invention consists in selecting transition values (IF_{I} and (SB_{J}), which are in each case equal to (IF_{L})/2 and (SB_{L})/2.

As a result of an example of implementation, the method according to the invention consists in
collecting additional data relating to the industrial activity,
dividing the additional data into a third subgroup and a fourth subgroup,
processing the data of the third and fourth subgroups to obtain a third value (v3) of an industrial parameter, known as profit contribution (GB), which corresponds to the third data subgroup, and a fourth value (v4) of another industrial parameter, known as transfer risk (RT) which corresponds to the fourth data subgroup, wherein the said values (v3, v4) lie between a minimum value and respectively predetermined limiting values (GB_{L}) and (RT_{L}),
using an additional two-dimensional representation with a horizontal axis which comprises the possible values of the industrial parameter corresponding to the profit contribution (GB) and with a vertical axis which comprises the possible values of the industrial parameter corresponding to the transfer risk (RT),
using transition values (GB_{I}) and (RT_{J}), which are smaller than the limiting values (GB_{L}) and (RT_{L}), and using the said limiting values (GB_{L}) and (RT_{L}) of the said industrial parameters, to delimit four approximately rectangular regions (A, B, C, D) in the two-dimensional representation, each of which corresponds to a particular industrial evaluation,
localizing the region in which the industrial activity is located, which is defined by the values (v3, v4) which represent the coordinates of a point in the two-dimensional representation,
issuing an additional evaluation report assigned to the industrial activity in such a manner, the content whereof is localized by the combination of the region in which the coordinate point (v1, v2) is localized, and the region in which the coordinate point (v3, v4) is localized, in order to provide information for creating an action plan.

As a result of an example of implementation, the method according to the invention consists in collecting additional data relating to the industrial activity by means of questionnaires.

As a result of an example of implementation, the method according to the invention consists in visualizing at least the region (A, B, C or D) in which the coordinate point (v3, v4) is localized in the form of an additional graph.

As a result of an example of implementation, the method according to the invention consists in selecting transition values (GB_{I} and (RT_{J}), which are in each case equal to (GB_{L})/2 and (RT_{L})/2.

As a result of an example of implementation, the method according to the invention consists in using data in the manner of cost analysis, access to additional profits, customer service, possibilities for access to new markets, and the possibility for increasing the industrial efficiency to determine the value (v3) of the profit contribution (GB) and using data in the manner of social considerations of the site, complexity of the tasks, documentation and standardization, effect on other methods, requirements for security and confidentiality, existence and availability of suitable suppliers, and planning uncertainties in order to determine the value (v4) of the transfer risk (RT).

As a result of an example of implementation, the method according to the invention consists in determining the values (v1, v2, v3, v4) by using a specific number of questions for each value, wherein each answer is selected from a finite number of possibilities, wherein a specific number of points is allocated and corrected by means of a weighting coefficient, wherein the weighted points determined in this manner are added and wherein the result of this addition is divided by the sum of all the weighting coefficients.

The aims according to the invention are likewise achieved with the aid of a computer program for controlling the operation of a computer, which comprises a group of commands for implementing the aforesaid method. Each process step according to the invention is therefore executed by one or a plurality of commands which are defined in the program. This program can advantageously be conditioned to control additional software programs in the style of “Excel” which are already installed on the computer.

The objects assigned to the present invention are likewise achieved with an apparatus for implementing the aforesaid method. This apparatus is worthy of note in that it comprises:
means for collecting the data which relates to the industrial activity,
means for dividing the data into the data subgroups,
means for processing, primarily by calculation, the data of all the subgroups in order to obtain values (v1, v2, v3, v4) of the industrial parameters corresponding to the subgroups, wherein the said values (v1, v2, v3, v4) lie between minimum values and the respectively determined limiting values (IF_{L}, SB_{L}) and (GB_{L}, RT_{L}),
means for representing in two-dimensional form with a horizontal axis which comprises the possible values of the industrial parameters,
means for using transition values which are smaller than the limiting values and using the said limiting values of the said industrial parameters to delimit four approximately rectangular regions (I, II, III, IV) or (A, B, C, D), each of which corresponds to a particular industrial evaluation,
means for localizing the region in which the industrial activity is located, which is defined by the values (v1, v2) and (v3, v4), which represent the coordinate of points in the two-dimensional representation,
and means for issuing an evaluation report assigned to the industrial activity in such a manner, its content depending on the combination of localized regions so that information is provided for preparing an action plan.

As a result of an example of implementation, the apparatus according to the invention comprises means for visualizing in the form of a screen in order to represent graphically the position of the coordinate points (v1, v2) and (v3, v4) in each case in relation to the regions (I, II, III, IV) and (A, B, C, D).

As a result of an example of implementation, the apparatus according to the invention comprises means for printing out in the manner of a printer in order to print out on the one hand the evaluation report and on the other hand a graphical representation of the coordinate points (v1, v2) and (v3, v4) in the corresponding regions (I, II, III, IV) and (A, B, C, D).

The invention and its advantages appear in further detail within the framework of the following description with exemplary embodiments and examples of implementation, which are given for illustration purposes with reference to the figures in the Annex, of which:

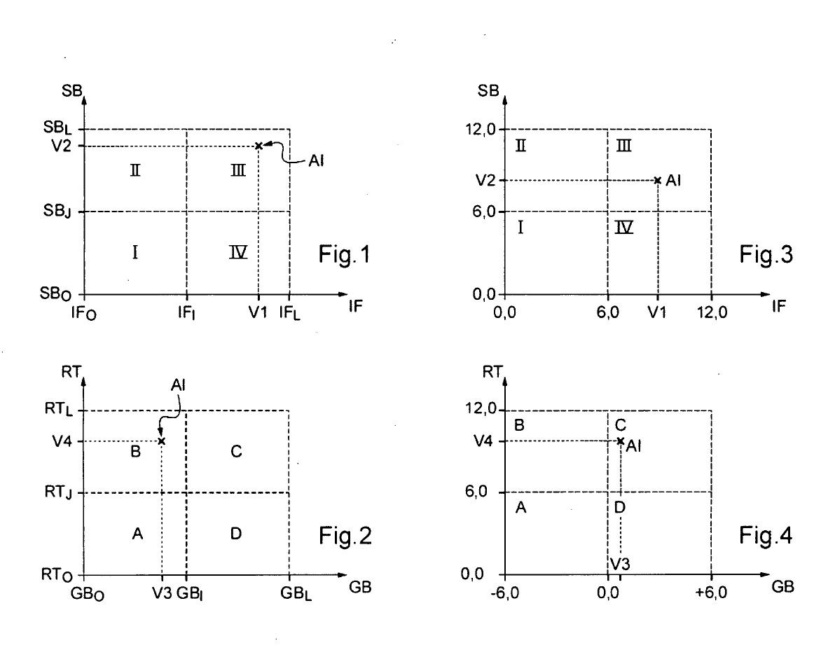

FIG. 1 illustrates an example for the technical processing of data relating to an industrial activity, and in particular the result of such processing which is represented by a display means,

FIG. 2 illustrates another example for the technical processing of additional data or parameters of an industrial activity, for example, the industrial activity which is the subject matter of FIG. 1, and in particular the result of such processing which is represented by a display means,

FIGS. 3 and 4 illustrate specific examples for the implementation of the method according to the invention.

Naturally, the present invention is subject to numerous variations with regard to its implementation. Although a plurality of embodiments are described, it is understandable that not all possible types can be described exhaustively. It is naturally conceivable that a described means or a described step or a described command may be replaced by an equivalent means without going beyond the scope of the present invention.

The method according to the invention implements steps which are explained hereinafter and relate to a general representation in FIGS. 1 and 2 and to a specific example in FIGS. 3 and 4.

The method consists in collecting data which relates to an industrial activity AI, for example, by means of questionnaires. These data are then distributed into two different subgroups which serve to define industrial parameters, which are respectively called internal capabilities IF and strategic importance SB. Each item of information is determined with the aid of a selection of an item of information from three, four, or five possible answers to a question. Each possible answer is allocated a specific number of points.

The data of all the subgroups are then processed to obtain a value (v1, v2) of an industrial parameter. The processing consists in weighting within each subgroup the number of points allocated to the selected answer with a specific coefficient, adding the results, and dividing the whole by the sum of all the weighting coefficients. In this way, the values (v1, v2) of the industrial parameters IF and SB are obtained, each lying between a minimum value and specific limiting values IF_{L} and SB_{L}. See also FIG. 1.

The method then consists in a two-dimensional representation with a horizontal axis which comprises the possible values of the internal capabilities (IF) and with a vertical axis which comprises possible values of the strategic importance (IR).

The following step consists in using transition values IF_{I} and SB_{J} which are smaller than the corresponding limiting values IF_{L}, SB_{L} and using the said limiting values to delimit four rectangular regions (I, II, III, IV) in the two-dimensional representation. Each region delimited in this manner corresponds to a particular industrial evaluation which forms the impetus for particular actions or particular strategic orientations.

As a consequence of the method according to the invention, the region in which the industrial activity AI is located, this being defined by the coordinates (v1, v2), is then localized.

The following step consists in issuing an evaluation report which is to be allocated to the industrial activity AI. This evaluation report allows information to be provided to prepare an action plan.

The method consists, for example, in visualizing in graphical form at least the region in which the point AI of the coordinates (v1, v2) is localized. The four regions (I, II, III, IV) as well as the point AI are preferably visualized.

For example, the transition values IF_{I} and SB_{J} are in each case equal to IF_{L}/2 and SB_{L}/2.

As a consequence of an example of implementation of the method according to the invention, the additional data relating to the industrial activity AI are collected and the sequence of steps described above is completely repeated.

The method consequently generates a second two-dimensional representation, as is illustrated with reference to FIG. 2. In this representation, the horizontal axis comprises the possible values of an industrial parameter, which is called the profit contribution GB, and the vertical axis comprises the possible values of an industrial parameter which is called transfer risk (RT). In this new representation, the industrial activity AI is defined by a coordinate point (v3, v4), which corresponds to values of the industrial parameters which were determined in the same manner as the values (v1, v2).

The following step consists in using transition values IF_{I} and SB_{J}, which are smaller than the corresponding limiting values IF_{L} and SB_{L} and using said limiting values to delimit four rectangular regions (I, II, III, IV) in the two-dimensional representation. Each region delimited in this manner corresponds to a particular industrial evaluation, which provides the stimulus for particular actions or particular strategic orientations.

As a consequence of this example of implementation, the method consists in issuing an additional evaluation report allocated to the industrial activity AI, the content of which is determined by the combination of the region in which the coordinate point (v1, v2) is localized and the region in which the coordinate point (v3, v4) is localized. This additional evaluation report therefore allows representative information relating to the industrial activity under consideration to be prepared to draw up an action plan or to define new industrial, financial, social or commercial priorities.

The additional data is collected, for example, by means of questionnaires and these data are processed in a manner identical to that described above and leading to the values (v1, v2).

One process step consists in likewise visualizing in the form of an additional graph at least the region in which the coordinate point (v3, v4) is localized.

As a result of an example of implementation of a method according to the invention, the transition values GB_{I} and RT_{J} are in each case equal to GB_{L}/2 and RT_{L}/2.

The regions I, II, III, IV are defined, for example as follows:

Region I: IF₀≦IF<IF_{I} and SB₀≦SB<SB_{J}

Region II: IF₀≦IF<IF_{I} and SB_{J}≦SB≦SB_{L}

Region III: IF_{I≦IF≦IF}_{L} and SB_{J}≦SB≦SB_{L}

Region IV: IF_{I≦IF≦IF}_{L} and SB₀≦SB<SB_{J}

The regions A, B, C, D are defined, as follows, for example:

Region A: GB₀≦GB<GB_{I} and RT₀≦RT<RT_{J}

Region B: GB₀≦GB<GB_{I} and RT_{J}≦RT≦RT_{L}

Region C: GB_{I}≦GB≦GB_{L} and RT_{J}≦RT≦RT_{L}

Region D: GB_{I}≦GB≦GB_{L} and RT₀≦RT<RT_{J}

The diagram in FIG. 1 is the result of an analysis of essential competences and the diagram in FIG. 2 is the result of a financial analysis and the transfer risk. An industrial activity AI, which is localized in the following specified regions, consequently has one of the following features:
Region I: this is an industrial activity outside the core profession. The industrial activity has a low strategic importance and is provided with internal capabilities, which are qualitatively lower or equivalent to the outside world. The transfer risk as well as the profit contribution for this industrial activity must be analyzed in order to estimate its cessation potential;
Region II: the industrial activity should be promoted. The industrial activity has a strong strategic potential but has internal capabilities, which are qualitatively lower or equivalent to the outside world. It is probable that this industrial activity will be promoted by means of the development of specific internal capabilities;
Region III: this is a professional core activity. The industrial activity has a strong strategic potential and has qualitatively higher internal capabilities than the outside world. It is probable that the industrial activity belongs to the internal know-how capital and this constitutes a significant competitive advantage.
Region IV: this is an industrial transition activity. The industrial activity is not interesting when viewed strategically but has very developed internal capabilities. The transfer risk and the profit contribution for this industrial activity must be analyzed in order to assess the interest in internal retention. It is probable that this industrial activity is not affected by future investments or development efforts;
Region A: the industrial activity has a low transfer risk and makes a smaller contribution to the profit than the contribution toward which it could be heading;
Region B: the industrial activity has a strong transfer risk and makes a smaller contribution to the profit than the profit toward which it could be heading. This type of industrial activity is undesirable and must be systematically associated with a reduction in the transfer risk and/or an improvement in the profit contribution.
Region C: the industrial activity has a strong transfer risk and contributes fully toward the profit;
Region D: the industrial activity has a low transfer risk and contributes fully toward the profit.

The method allocates a pair of regions which is specified in the following category to each industrial activity AI. Standard recommendations which read as follows pertain to each category:
for Category I-A: the industrial activities which have no strategic potential and which do not contribute sufficiently to the profit are candidates for cessation. The group has no sufficiently specific means which allow it to implement these activities and the transfer risk is low. The group must consider the development of staff in the direction of industrial professional core activities and restrict investments;
for Category I-B: these activities have no strategic importance and the group does not have the relevant capabilities to execute these activities and they make no contribution to the profit. The transfer risk is high and the group should either expect to reduce the transfer risk (improve documentation, develop suppliers etc.) or invest in production and infrastructure to increase the efficiency and reduce the costs (introduce more effective production technologies). In the first case, the activity comes within Category I-A and in the second case, the activity is converted into an activity from Category I-C;
for Category I-C: these activities do not pertain to the professional core, have a high transfer risk, and have a high monetary added value. There are no economic grounds for ceasing from these activities. It is probable that the internal capacities will be improved for executing these activities (moving these activities or competences to Category IV-C) and their monetary value will be retained or improved;
for Category I-D: these activities do not pertain to the professional core, and have a low transfer risk despite an appreciable monetary added value. As for the preceding category, it is possible to develop the internal capabilities in order to secure the corresponding monetary effects. If these activities were to be separated from the group, there would only be a financial impact for the group but no permanent loss of know-how;
for Category II-A: promoting competences in the Region II-A would be costly for the group and they offer alternatives to purely internal manufacture. There are two alternatives for action. On the one hand, to start innovation process with cost targets and make investments in more efficient resources to arrive at Category III-D. On the other hand, to enter into external partnerships. Since this involves highly strategic competences, the last hypothesis necessitates a strategic partner who shares the risks in order to achieve efficiency in the cost area and retain a part of mastering the competences within the group;
for Category II-B: promoting the competences in this category constitutes a strategic potential which would not bring the contribution to the profit which it could bring. Since this activity has a high transfer risk, innovations based on efficiency and cost reduction must be used to arrive at Category III-C in the future;
for category II-C: these are competences which will give the group a measurable competitive advantage in future and will allow an appreciable contribution to the profit. The aim of the corresponding actions is to invest and generate a technological leadership;
for Category II-D: these are competences to be promoted and not safeguarded since they are strategically important. However, the competitors have equivalent capabilities. The group has a measurable strategic and financial interest in internally promoting these activities. It can be considered whether one goes into direct competition or whether one goes into cooperation with an established market participant;
for Category III-A; the competences of the professional core in Region A are costly for the group and offer the possibilities of obtaining these activities externally. There are two possibilities for action. To increase the efficiency to arrive at Category III-D or to seek partners for external delivery. Since these are professional core competences, the last hypothesis necessitates a strategic partner who shares the risks in order to achieve efficiency in the cost area and retain a part of mastering the competences within the group;
for Category III-B: the professional core competences in this category constitute a strategic value which does not bring the contribution to the profit that it could bring. Since this activity has a high transfer risk, an improvement in efficiency should envisage automation in such a manner as to arrive at Category III-C.
for Category III-C: these are competences which give the group a measurable competitive advantage and contribute substantially to the profit of the group. The aim herewith is to obtain an advantage over the competitors by means of investments and differentiation strategies;
for Category III-D: these professional competences must be defended because they are important from the strategic point of view. However, the competitors possess comparable capabilities. The group has a strategic and a measurable financial interest in retaining these competences internally. It must be expected that the range of these competences will be expanded by, for example, offering this activity to other customers outside the group;
for Category IV-A: these transition competences make to contribution to the profit of the group and are candidates for investment cutbacks. The group must develop the corresponding resources in the direction of professional core competences or competences to be promoted, as soon as possible and expect a transfer to a supplier. The capabilities of the group can be part of an agreement with an external supplier if they are sufficiently competitive.
for Category IV-B: these transition activities achieve no contribution to the profit of the group. Since there is a high transfer risk, the group must expect a reduction in this transfer risk (with better documentation, development of the suppliers etc.) in order to arrive at Category IV-A. The group could also invest in efficiency-increasing measures to become more efficient and to reduce costs (such as introducing modern production technologies). In this case, the activity is converted to Category IV-C.
for Category IV-C: these transition activities have a high transfer risk and a significant monetary added value. There are no economic grounds for parting from these activities. It can be expected that a subcompany will be founded internally which integrates the professional core competences. This allows other customers to be reached in contrast to internal retention.
for Category IV-D: these transition activities have a low transfer risk and a considerably monetary added value. As for the previous category, the activity and the accompanying positive financial effects can be maintained or these can be externalized. If these activities should be allocated externally (possibly for offsetting reasons), this “merely” results in a financial impact for the group but not in any permanent loss of know-how.

With regard to the industrial activities in the other categories, it may prove to be advantageous, or even essential to undertake corrective measures to change the category.

Standard recommendations which take into account the category in which an industrial activity AI is classified are advantageously contained in the additional evaluation report.

In the example for the implementation of the method according to the invention, which is illustrated by FIGS. 3 and 4, the following values were recorded for the industrial parameters in order to designate the graphical representations:

SB₀=0.0; SB_{J}=6.0; SB_{L}=12.0

IF₀=0.0; IF_{I}=6.0; IF_{L}=12.0

RT₀=0.0; RT_{J}=6.0; RT_{L}=12.0

GB₀=−6.0; GB_{I}=0.0; IF_{L}=+6.0

The following five questions were used to determine the value of the strategic importance parameter SB:
−1/Does the activity AI meet the expectations of the customer?

| Possible answers | Points | weighting |
|---|---|---|
| No | 0 | 0.2 |
| Secondary expectations | 6 | 0.2 |
| Primary expectations | 12 | 0.2 |

−2/Does the activity allow the products to be distinguished from competing products?

| Possible answers | Points | weighting |
|---|---|---|
| No | 0 | 0.2 |
| Partly | 6 | 0.2 |
| Yes | 12 | 0.2 |

−3/Does the activity have a strong potential for future innovations?

| Possible answers | Points | weighting |
|---|---|---|
| No | 0 | 0.2 |
| Partly | 6 | 0.2 |
| Yes | 12 | 0.2 |

−4/Is the activity common to many methods or merely part of a single industrial method?

| Possible answers | Points | weighting |
|---|---|---|
| A single one | 0 | 0.2 |
| Several | 6 | 0.2 |
| Many | 12 | 0.2 |

−5/Is the activity rather isolated or does it interact with other activities?

| Possible answers | Points | weighting |
|---|---|---|
| Rather isolated | 0 | 0.2 |
| Some interactions | 6 | 0.2 |
| Many | 12 | 0.2 |

The following four questions were used to determine the value of the internal capabilities IF:
−1/Has the company mastered the industrial method?

| Possible answers | Points | weighting |
|---|---|---|
| No | 0 | 0.25 |
| Partly | 6 | 0.25 |
| Yes | 12 | 0.25 |

−2/What are the capabilities of the work force compared to other companies?

| Possible answers | Points | weighting |
|---|---|---|
| Inferior | 0 | 0.25 |
| Similar | 6 | 0.25 |
| Better | 12 | 0.25 |

−3/Is the company technically sufficiently well equipped to master this activity?

| Possible answers | Points | weighting |
|---|---|---|
| Less than others | 0 | 0.25 |
| Similar to others | 6 | 0.25 |
| Better | 12 | 0.25 |

−4/Does the company have other values (patents, training; finances) in relation to this activity?

| Possible answers | Points | weighting |
|---|---|---|
| No | 0 | 0.25 |
| Few significant | 6 | 0.25 |
| Yes, significant | 12 | 0.25 |

The following seven questions were used to determine the value of the risk transfer parameter RT:
−1/Would the transfer of this activity have social effects?

| Possible answers | Points | weighting |
|---|---|---|
| No | 0 | 1/7 |
| Few significant | 6 | 1/7 |
| Strong effect | 12 | 1/7 |

−2/Is the activity very complex or the company not currently in a position to master it correctly?

| Possible answers | Points | weighting |
|---|---|---|
| No | 0 | 1/7 |
| Partly | 6 | 1/7 |
| Very complex | 12 | 1/7 |

−3/What is the standardization and documentation level of this activity?

| Possible answers | Points | weighting |
|---|---|---|
| Very good | 0 | 1/7 |
| Moderate | 6 | 1/7 |
| Poor | 12 | 1/7 |

−4/Would the transfer of this activity have effects on the coordination with adjacent activities?

| Possible answers | Points | weighting |
|---|---|---|
| No | 0 | 1/7 |
| Some | 6 | 1/7 |
| Yes | 12 | 1/7 |

−5/Does the activity imply special safety considerations?

| Possible answers | Points | weighting |
|---|---|---|
| No | 0 | 1/7 |
| Yes but not critical | 6 | 1/7 |
| Yes | 12 | 1/7 |

−6/Are there suitable suppliers on the market?

| Possible answers | Points | weighting |
|---|---|---|
| Yes, many | 0 | 1/7 |
| Yes, some | 6 | 1/7 |
| No, none | 12 | 1/7 |

−7/Can necessary capacities and predicted results of this activity be planned easily?

| Possible answers | Points | weighting |
|---|---|---|
| Yes | 0 | 1/7 |
| Partly | 6 | 1/7 |
| No | 12 | 1/7 |

The following five questions were used to determine the value of the profit contribution parameter GC:
−1/Will additional profit be achieved if the activity is implemented internally?

| Possible answers | Points | weighting |
|---|---|---|
| Significant losses | −6 | 0.2 |
| Low losses | −3 | 0.2 |
| No effect | 0 | 0.2 |
| Yes, some | +3 | 0.2 |
| Yes, high | +6 | 0.2 |

−2/In the event of internal implementation, will there be a positive contribution to customer service turnover?

| Possible answers | Points | weighting |
|---|---|---|
| Significant losses | −6 | 0.2 |
| Low losses | −3 | 0.2 |
| No effect | 0 | 0.2 |
| Yes, some | +3 | 0.2 |
| Yes, high | +6 | 0.2 |

−3/Could the activity be made more efficient if implemented internally?

| Possible answers | Points | weighting |
|---|---|---|
| No, already efficient | +6 | 0.2 |
| No change expected | 0 | 0.2 |
| Yes, very | −6 | 0.2 |

−4/Would the activity have potential for opening up new markets if implemented internally?

| Possible answers | Points | weighting |
|---|---|---|
| Significant losses | −6 | 0.2 |
| Slight losses | −3 | 0.2 |
| No effect on markets | 0 | 0.2 |
| Yes, some | +3 | 0.2 |
| Yes, many | +6 | 0.2 |

−5/Was a positive financial assessment made?

| Possible answers | Points | weighting |
|---|---|---|
| Highly negative | −6 | 0.2 |
| Rather negative | −3 | 0.2 |
| None | 0 | 0.2 |
| Rather positive | +3 | 0.2 |
| Very positive | +6 | 0.2 |

It is clear that the weighting applied hereabove for processing the industrial data may be improved, modulated or adapted from one question to another without departing from the scope of the present invention. Thus, for each question a weighting coefficient can be selected from the following list:

0; 0.5/T; 1/T; 2/T; T, where T is the number of questions to be answered for a given industrial parameter.

In the example of implementation illustrated in FIGS. 3 and 4, the following values are thus obtained for the industrial activity AI:

$$\begin{matrix}GB = ( 6 \times 0.2 + 0 \times 0.2 + ( - 6 ) \times 0.2 + 3 \times 0.2 + 0 \times 0.2 ) / ( 5 \times 0.2 ) \\ = 0.6\end{matrix}$$

$$\begin{matrix}RT = ( \begin{matrix}6 \times 1 / 7 + 12 \times 1 / 7 + 12 \times 1 / 7 + 12 \times 1 / 7 + \\ 0 \times 1 / 7 + 6 \times 1 / 7 + 6 \times 1 / 7\end{matrix} ) / ( 7 \times 1 / 7 ) \\ = 7.7\end{matrix}$$

$$\begin{matrix}SB = ( 12 \times 0.2 + 12 \times 0.2 + 6 \times 0.2 + 6 \times 0.2 + 6 \times 0.2 ) / ( 5 \times 0.2 ) \\ = 8.4\end{matrix}$$

$$and$$

$$\begin{matrix}IF = ( 12 \times 0.25 + 6 \times 0.25 + 6 \times 0.25 + 12 \times 0.25 ) / ( 4 \times 0.25 ) \\ = 9.0\end{matrix}$$

For each answer there are positive or negative points which are multiplied with a weighting. For each parameter IF, RT, GB, SB the weighted values are then added and the results is divided by the sum of the corresponding weightings.

From this it follows that this activity comes in Category (III, C) and that this is an essential activity which should be retained.

1. A method for the technical and economic analysis of an industrial activity,
characterized in that it consists in:
collecting the data which relates to the industrial activity,
dividing the data into a first subgroup and a second subgroup,
processing the data in all the subgroups in order to obtain a first value (v1) of an industrial parameter, known as internal capabilities (IF), which corresponds to the first data subgroup and a second value (v2) of another industrial parameter, known as strategic importance (SB) which corresponds to the second data subgroup, wherein the said values (v1, v2) lie between minimum values (IF₀, SB₀) and respectively predetermined limiting values (IF_{L}) and (SB_{L}), using a two-dimensional representation with a horizontal axis, which comprises the possible values of the industrial parameters, which corresponds to the internal capabilities (IF) and with a vertical axis which comprises the possible values of the industrial parameter, which corresponds to the strategic importance (SB),
using transition values (IF_{I}) and (SB_{J}), which are smaller than the limiting values (IF_{L}) and (SB_{L}), and using the said limiting values (IF_{L}) and (SB_{L}) of the said industrial parameters, to delimit four approximately rectangular regions (I, II, III, IV) in the two-dimensional representation, each of which corresponds to a particular industrial evaluation,
localizing the region in which the industrial activity is located, which is defined by the values (v1, v2) which represent the coordinates of a point in the two-dimensional representation,
issuing an evaluation report assigned to the industrial activity in such a manner, which provides information for creating an action plan.

2. The method for the technical and economic analysis of an industrial activity according to claim 1,
characterized in that this consists in collecting data relating to the industrial activity by means of questionnaires.

3. The method according to claim 1,
characterized in that this consists in graphically visualizing at least the region (I, II, III or IV) in which the coordinate point (v1, v2) is localized.

4. The method according to claim 1,
characterized in that this consists in selecting transition values (IF_{I} and (SB_{J}), which are in each case equal to (IF_{L})/2 and (SB_{L})/2.

5. The method according to claim 1,
characterized in that this consists in
collecting additional data relating to the industrial activity,
dividing the additional data into a third subgroup and a fourth subgroup,
processing the data of the third and fourth subgroups to obtain a third value (v3) of an industrial parameter, known as profit contribution (GB), which corresponds to the third data subgroup, and a fourth value (v4) of another industrial parameter, known as transfer risk (RT) which corresponds to the fourth data subgroup, wherein the said values (v3, v4) lie between minimum values (GB₀, RT₀) and respectively predetermined limiting values (GB_{L}) and (RT_{L}),
using an additional two-dimensional representation with a horizontal axis which comprises the possible values of the industrial parameter corresponding to the profit contribution (GB) and with a vertical axis which comprises the possible values of the industrial parameter corresponding to the transfer risk (RT),
using transition values (GB_{I}) and (RT_{J}), which are smaller than the limiting values (GB_{L}) and (RT_{L}), and using the said limiting values (GB_{L}) and (RT_{L}) of the said industrial parameters, to delimit four approximately rectangular regions (A, B, C, D) in the two-dimensional representation, each of which corresponds to a particular industrial evaluation,
localizing the region in which the industrial activity is located, which is defined by the values (v3, v4) which represent the coordinates of a point in the two-dimensional representation,
issuing an additional evaluation report assigned to the industrial activity in such a manner, the content whereof is localized by the combination of the region in which the coordinate point (v1, v2) is localized, and the region in which the coordinate point (v3, v4) is localized, in order to provide information for creating an action plan.

6. The method for the technical and economic analysis of an industrial activity according to claim 5,
characterized in that this consists in collecting additional data relating to the industrial activity by means of questionnaires.

7. The method according to claim 5,
characterized in that this consists in visualizing at least the region in which the coordinate point (v3, v4) is localized in the form of an additional graph.

8. The method according to claim 5,
characterized in that this consists in selecting transition values (GB_{I} and (RT_{J}), which are in each case equal to (GB_{L})/2 and (RT_{L})/2.

9. The method according to claim 5,
characterized in that this consists in using data in the manner of cost analysis, additional profits, customer service, possibilities for access to new markets, possibility for increasing the industrial efficiency to determine the value (v3) of the profit contribution (GB) and using data in the manner of social considerations of the site, complexity of the tasks, documentation and standardization, effect on other methods, requirements for security and confidentiality, availability of suitable suppliers, uncertainties in order to determine the value (v4) of the transfer risk (RT).

10. The method according to claim 5,
characterized in that this consists in determining the values (v1, v2, v3, v4) by using a specific number of questions for each value, wherein each answer is selected from a finite number of possibilities, wherein a specific number of points is allocated and corrected by means of a weighting coefficient, wherein the weighted points determined in this manner are added and wherein the result of this addition is divided by the sum of all the weighting coefficients.

11. A computer program for controlling the operation of a computer, wherein the said program comprises a group of commands, which implement the method according to claim 1.

12. An apparatus for implementing the method according to claim 1,
characterized in that this comprises:
means for collecting the data which relates to the industrial activity,
means for dividing the data into the data subgroups,
means for processing, primarily by calculation, the data of all the subgroups in order to obtain values (v1, v2, v3, v4) of the industrial parameters corresponding to the subgroups, wherein the said values (v1, v2, v3, v4) lie between zero and the respectively determined limiting values (IF_{L}, SB_{L}) and (GB_{L}, RT_{L}),
means for representing in two-dimensional form with a horizontal axis which comprises the possible values of the industrial parameters,
means for using transition values which are smaller than the limiting values and using the said limiting values of the said industrial parameters to delimit four approximately rectangular regions (I, II, III, IV) or (A, B, C, D), each of which corresponds to a particular industrial evaluation,
means for localizing the region in which the industrial activity is located, which is defined by the values (v1, v2) and (v3, v4), which represent the coordinate of points in the two-dimensional representation,
and means for issuing an evaluation report assigned to the industrial activity in such a manner, its content depending on the combination of localized regions so that information is provided for preparing an action plan.

13. The apparatus according to claim 12,
characterized in that it comprises means for visualizing in the form of a screen in order to represent graphically the position of the coordinate points (v1, v2) and (v3, v4) in each case in relation to the regions (I, II, III, IV) and (A, B, C, D).

14. The apparatus according to claim 12,
characterized in that it comprises means for printing out in the manner of a printer in order to print out on the one hand the evaluation report and on the other hand a graphical representation of the coordinate points (v1, v2) and (v3, v4) in the corresponding regions (I, II, III, IV) and (A, B, C, D).

15. The apparatus according to claim 13,
characterized in that it comprises means for printing out in the manner of a printer in order to print out on the one hand the evaluation report and on the other hand a graphical representation of the coordinate points (v1, v2) and (v3, v4) in the corresponding regions (I, II, III, IV) and (A, B, C, D).

16. The method according to claim 2,
characterized in that this consists in graphically visualizing at least the region (I, II, III or IV) in which the coordinate point (v1, v2) is localized.

17. The method according to claim 2,
characterized in that this consists in selecting transition values (IF_{I} and (SB_{J}), which are in each case equal to (IF_{L})/2 and (SB_{L})/2.

18. The method according to claim 2,
characterized in that this consists in
collecting additional data relating to the industrial activity,
dividing the additional data into a third subgroup and a fourth subgroup,
processing the data of the third and fourth subgroups to obtain a third value (v3) of an industrial parameter, known as profit contribution (GB), which corresponds to the third data subgroup, and a fourth value (v4) of another industrial parameter, known as transfer risk (RT) which corresponds to the fourth data subgroup, wherein the said values (v3, v4) lie between minimum values (GB₀, RT₀) and respectively predetermined limiting values (GB_{L}) and (RT_{L}),
using an additional two-dimensional representation with a horizontal axis which comprises the possible values of the industrial parameter corresponding to the profit contribution (GB) and with a vertical axis which comprises the possible values of the industrial parameter corresponding to the transfer risk (RT),
using transition values (GB_{I}) and (RT_{J}), which are smaller than the limiting values (GB_{L}) and (RT_{L}), and using the said limiting values (GB_{L}) and (RT_{L}) of the said industrial parameters, to delimit four approximately rectangular regions (A, B, C, D) in the two-dimensional representation, each of which corresponds to a particular industrial evaluation,
localizing the region in which the industrial activity is located, which is defined by the values (v3, v4) which represent the coordinates of a point in the two-dimensional representation,
issuing an additional evaluation report assigned to the industrial activity in such a manner, the content whereof is localized by the combination of the region in which the coordinate point (v1, v2) is localized, and the region in which the coordinate point (v3, v4) is localized, in order to provide information for creating an action plan.

19. The method according to claim 6,
characterized in that this consists in visualizing at least the region in which the coordinate point (v3, v4) is localized in the form of an additional graph.
